(19) United States
(12) Patent Application Publication
(10) Pub. No.: US 2020/0125099 A1
(43) Pub. Date: Apr. 23, 2020

(54) AUTOMATED DRONE LEASE OPERATING SYSTEM (ADLOS) AUTOMATED DRONE OIL FIELD INSPECTION SYSTEM AND METHOD

(71) Applicant: Scott Michael PANTHAKY, Midland, TX (US)

(72) Inventor: Scott Michael PANTHAKY, Midland, TX (US)

(21) Appl. No.: 16/658,871

(22) Filed: Oct. 21, 2019

Related U.S. Application Data
(60) Provisional application No. 62/748,879, filed on Oct. 22, 2018.

(51) Int. Cl. G05D 1/00; H04N 5/225; H04N 5/247; G06K 9/00; B64C 39/02; B64F 1/36; B64F 1/00; B64D 47/08; G01W 1/02

(52) U.S. Cl. CPC G05D 1/0094; H04N 5/2253; H04N 5/247; G06K 9/00664; H04W 88/08; B64F 1/362; B64F 1/005; B64D 47/08; G01W 1/02; B64C 39/024

(57) ABSTRACT

An automated autonomous drone for oil field inspection services is disclosed. The system be method use an automatically scheduled and flown data collection drone, deployable base station containing a landing dock, power supply, articulating shelter, wireless data transmission system, weather station, and computing systems and methods to control the system both locally and remotely.

### CLAIMS OF PRIORITY AND CROSS REFERENCE TO RELATED APPLICATION(S)

This application claims the benefit of priority of U.S. provisional application No. 62/748,879 filed in the U.S. Patent & Trademark Office on Oct. 22, 2018, the disclosure of which is incorporated herein by reference in its entirety

### FIELD OF THE INVENTION

This invention relates to the field of daily oil field inspection (a.k.a. Lease Operating). This invention relates specifically to the automation of certain inspection services using an automatically scheduled and flown data collection drone, deployable base station containing a landing dock, power supply, articulating shelter, wireless data transmission system, weather station, and computing systems and methods to control the system both locally and remotely.

### BACKGROUND OF THE INVENTION

Oil field operations are a well-known and long established world-wide business. Daily inspections are performed in any oil extraction field across the globe. Owing to the nature of the product(s) being produced, in that the product is both valuable and relatively environmentally toxic, eyes on the field are a necessary and desired requirement of such operations. If spills went unchecked for almost any amount of time, the lost product and clean-up costs, and local environmental damage accrue rapidly. Hence, people are tasked with checking daily on most all oil well operations, each and every well and facility in production. This is time consuming and not particularly rewarding work in that most days, little is observed. Yet, each day, regardless, the trek to the well, a cursory survey, and return are necessary. With wells proximate one another, the work can be relatively efficient, but the roundtrip to each site cannot be eliminated. Although some of the monitoring can be readily automated, i.e., tank content and level, power supply, gross fluid rates, pressures, pump conditions, motor status', temperatures, etc.; leak detection across the many facilities always requires physical observation.

Typically, for surface oil-field extraction applications in rural areas, anywhere from 660′-1,320′ and sometimes much more between inspection sites are common, and fields with many wells may have as few as 4 or as many as 32 or 64 wells per square mile. Current best-practices in operating these systems include a lease operator employee who must drive a vehicle to inspect each well site and tank battery daily and report back to management. Many lease operators drive upwards of 10,000-12,000 miles per month. With most publicly operated oil companies managing thousands or tens of thousands of individual sites, and thousands of lease operators, the potential to save resources by automating monitoring of daily oilfield equipment operation is enormous.

### SUMMARY OF THE INVENTION

The invention is an Automated Drone Lease-Operator System and method. To wit: An Automated Drone Lease-Operator System (ADLO System) herein performs all of the functions associated with the daily lease operator inspection with a fraction of the resource expenditure compared to current methods.

### BRIEF DESCRIPTION OF THE DRAWING(S)

FIG. 1 shows a schematic of an oil field inspection drone route for an automated drone system in accord with the present invention.

FIG. 2 shows a schematic of a base ADLO Station in accord with the present invention.

### DETAILED DESCRIPTION OF THE PREFERRED EMBODIMENT

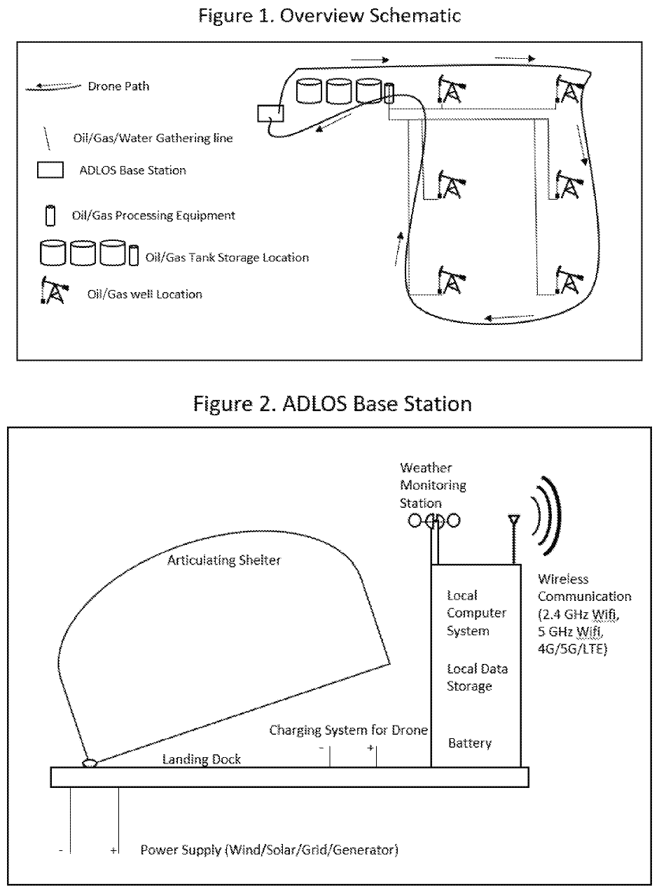

The ADLO System (See FIG. 1) includes: 1) one or many ADLOS Base Station(s), 2) the Automated Drone(s) (Drone), 3) and Management Software with an automated and user-controlled component. (For example, as disclosed in U.S. Pat. No. 9,678,507, which is incorporated herein by reference.) The ADLOS Base Station includes: a combination landing-area charging dock, electronic weather station, cellular/other radio connection, moving shelter for a gyroscopically stabilized drone with imaging cameras, and any power supply. The Drone has imaging capability built for its specific tasks which may be variable, and a combination battery contact/leg-landing system that allows the drone to charge its batteries when it lands at the ADLO Station landing-area. The Management Software will control the ADLO's daily actions with limited human management or supervision. In operation, the ADLO System could be installed at any oilfield lease remote location, and serve as a daily inspection and report for anomalies.

For example: At a specified time each day, the ADLO Station checks for weather or other delaying conditions through internet access and its own electronic weather-station. If clear it then opens or moves its shelter to allow the drone to leave the landing/charging pad. The Drone then takes off and follows a predetermined inspection path and records high-quality video and still images of the inspection path and targets. Once the Drone is finished with its path, it returns to the ADLO Station to charge. While charging the Management Software will control the ADLO Station to analyze on site or transmit the Drone's recorded image data over the cellular connection to an outside database. At this outside database, the user end Management Software further organizes and analyses the image data to look for anomalies when comparing it to previously recorded control data. The Management Software then gathers the anomalies and sends an alert to a human operator who then works to verify and solve the problem. The Drone may be further directed remotely for verification or re-inspection at any time. Any combination of multiple drones or ADLO bases to cover the needed oil well field could be implemented to work together to accomplish the task with relatively small, technologically available drone hardware.

With the integration of high-quality video, infra-red video, and GPS capability, the ADLOS system will be able to quickly compare previously recorded “control” images of equipment and facilities, with each daily recorded video at each of its positions using GPS. Using this method it can quickly scan for anomalies in the image data which would signal a leak or spill occurrence. The use of infra-red video and image-processing software will be able to deduce fluid levels in tanks, and using known values for measurements in the tanks and GPS to confirm which tanks are inspected, will be able to calculate fill rates in storage tanks when compared to previous recordings of the same data. For 3-phase separating or two-phase separating equipment, fluid and gas interfaces in the vessel will show a temperature differential on the outside, allowing the Drone to record working or deficient operations within the separator. Using infra-red, even the polished rod temperature could be measured to deduce whether the specific well was making fluid and keeping its polished rod cool. Natural gas leaks could be spotted with infra-red easier than with the naked eye. Gearboxes and bearings could be compared by their temperature, showing if they need replacement. If the specified well, spill, leak, or any occurrence is flagged by the system a human may then be notified to problem-solve and perhaps drive to the location to solve the problem, or they may be able to actuate other services or equipment to solve or restrain the problem.

Although the distances covered by humans making the same inspections would have to be over the lease-roads, the drone could fly ‘line of sight’ greatly reducing its distance traveled as it needs to move from well site to well site. Also, the drone could fly at relatively high speeds while recording high quality video, to be slowed down for inspection and analysis at a later time, allowing for the drone to cover maximum ground per battery charge. Although the data would be large, it could be processed locally at the ADLOS Base station, before sending any flagged data to the controller, to reduce transmission time. However, the idle time for the ADLOS Base station would be ample, and should allow enough time each day for Gigabytes worth of wireless transmission once a satisfactory inspection is complete. Once the Drone has completed an inspection and docked, a 5.4 GHz connection to the Drone software can allow the drone to quickly offload the recently captured video data to the local storage on the base station in order to quickly charge and run another inspection in the meantime if needed. A 2.4 Ghz local WiFi connection can also serve as an inspection or login site for a human lease operator in the field. If inclement weather or other conditions did not allow for the upload and transmission of the Base Station video to management, a human operator could drive to the location and wirelessly download and inspect the data on site.

Furthermore, with the cell phone connection available, MAC addresses for those wireless devices in the area within connective distance to the Base Station could be recorded, “clocking in” and “clocking out” specified and known devices can serve as another point of tracking for human operators who may frequent the area for repairs. The connection could even be used to notify the human lease operator once they near a problem that there is something with physical attention needed, through their cell phone or other means.

Most oil-field well sites are in rural areas, with no human population. Automated Drones could safely fly with minimal and currently available obstacle-avoidance techniques, and, considering the inspection target is always near the surface, would never need to fly above 100′ in elevation or more than a few miles in distance, making the automation and data gathering operation of the drone almost impossibly unlikely to interfere with other air traffic. There would also be little or no disturbance from human-interference issues where flying over crowded or populated areas would be an issue. The amount of human time saved, and the vehicular and fuel resources expended to complete this same task daily for hundreds of thousands of wells could be saved and used to further efficiencies and environmental responsibility in the field of surface equipment monitoring for oilfield production operations.

Recently the Permian Basin has experienced weeks of wet weather, leading to many leases and even large areas being inaccessible due to low water crossings, washed out lease roads, etc. If an ADLO System was implemented during these times, operators could continue to monitor their production and greatly improve run time and efficiency while continuing to monitor and mitigate environmental issues despite human operators being unable to access the location easily.

While human visits are the standard of today, there is not much a small operator can do to guarantee that a contract service is actually visiting their operations daily. By removing the human component, a drone can work daily without personal problems, road safety issues, H2S training, etc. If the drone was equipped with H2S sensing hardware (available in many forms today), it could detect areas that were not safe for humans to travel and still complete the inspection. Being in the air, it could more readily detect gas emissions, and if one were spotted, fly near to sniff for poisonous H2S before allowing a human operator into the area.

If workover or drilling operations were being conducted in or near the field of inspection, the drone could be used in a “bird dog” mode to supervise and oversee operations from Management offices well away from the field, again saving time, increasing safety, efficiency, and responsibility to the operation.

What is claimed is:

1. An automated oil field inspection drone system, comprising: a combination landing-area charging dock, an electronic weather station, a cellular/other radio connection to said dock, an articulated shelter for storing a gyroscopically stabilized drone equipped with imaging cameras, and power supply, wherein the drone has imaging capability for specific oil field observation tasks, and a combination battery contact/leg-landing system within the articulated shelter that enables the drone to charge its batteries when it lands and is enclosed within the shelter.

2. A method of observing oil field operations using a self-contained autonomous drone, comprising the steps of:
checking for weather or other delaying conditions through internet access and a drone associate local electronic weather-station and, thereafter, when cleared;
opening a drone shelter door for drone operations to commence;
flying the drone off and following a predetermined inspection path and recording high-quality video and still images of the oil field inspection path and targets;
finishing the recording step and thereafter returning to said shelter; and,
forwarding electronic records of daily observation to a separate remote location, and analyzing the information for anomalies and other action items.
